(19) United States
(12) Patent Application Publication
(10) Pub. No.: US 2023/0375119 A1
(43) Pub. Date: Nov. 23, 2023

(54) CONNECTION STRUCTURE OF VALVE ASSEMBLY

(71) Applicant: Chieh-An HUNG, Taichung City (TW)

(72) Inventor: Chieh-An HUNG, Taichung City (TW)

(21) Appl. No.: 17/749,770

(22) Filed: May 20, 2022

(51) Int. Cl. F16L 37/47; F16L 37/12; F16L 43/02

(52) U.S. Cl. CPC F16L 37/47; F16L 37/1225; F16L 43/02

(57) ABSTRACT

A connection structure of a valve assembly contains: a body, a connecting pipe, and a C-shaped retainer. The body includes an accommodation chamber for receiving a ball valve, and a wrench is configured to turn on/off the ball valve. The body further includes a threaded tube, a water-supply coupling section, a fitting portion, a water stop ring, an engagement rib, and two locating protrusions. The connecting pipe is connected with the water-supply coupling section to form the valve assembly and includes a joining section, a groove, and a defining orifice configured to engage with the fitting portion of the water-supply coupling section of the body. The C-shaped retainer includes two retaining wings for engaging with the joining section of the connecting pipe and the engagement rib of the body, and the C-shaped retainer includes a C-shaped bridge configured to connect the two retaining wings.

### FIELD OF THE INVENTION

The present invention relates to a connection structure of a valve assembly which contains a body, a connecting pipe connected with the body to form the valve assembly, and a C-shaped retainer configured to engage the body and the connecting pipe, thus connecting the body with the connecting pipe or removing the body from the connecting pipe easily.

### BACKGROUND OF THE INVENTION

A conventional water supply system is fixed in a building and contains at least one control valve configured to control water equipment and the external water supply system, thus supplying water or stopping water.

The control valve is received in a receiving box on a predetermined position of the building, wherein a water-supply coupling section of a respective one control valve is connected with the water supply system, and an outflow section is coupled with a connection pipe of the water equipment. The respective one control valve has an accommodation chamber defined therein and configured to receive a ball valve, wherein a wrench is configured to switch water flow in the water supply system and the water equipment.

The valve assembly is one-piece formed, so the ball valve is damaged or is easy to leak water after a period of using time, and it is required to replace the ball valve. However, it is troublesome to remove the control valve from the receiving box and to accommodate another new control valve in the receiving box.

The present invention has arisen to mitigate and/or obviate the afore-described disadvantages.

### SUMMARY OF THE INVENTION

The primary object of the present invention is to provide a connection structure of a valve assembly which contains a body, a connecting pipe connected with the body to form the valve assembly, and a C-shaped retainer configured to engage the body and the connecting pipe, thus connecting the body with the connecting pipe or removing the body from the connecting pipe easily.

To obtain above-mentioned aspect, a connection structure of a valve assembly provided by the present invention contains: a body, a connecting pipe, and a C-shaped retainer.

The body includes an accommodation chamber defined in the body and configured to receive a ball valve, and a wrench is configured to turn on/off the ball valve. The body further includes a threaded tube extending from a side of the body, a water-supply coupling section extending from a bottom of the body, and a fitting portion extending from a bottom of the water-supply coupling section. A diameter of the fitting portion is less than a diameter of the water-supply coupling section, and the body further includes a water stop ring engaged on an outer wall of the fitting portion, an engagement rib surrounding around the outer wall of the fitting portion and located above the water stop ring, and two locating protrusions extending from two opposite positions of the engagement rib.

The connecting pipe is connected with the water-supply coupling section of the body to form the valve assembly, and the connecting pipe includes a joining section extending from a top of the connecting pipe. A diameter of the joining section is more than a diameter of the connecting pipe, and the connecting pipe further includes a groove defined in a top of the joining section, two locking cutouts formed on two opposite positions of the joining section and configured to engage with the two locating protrusions of the body, such that a defining orifice of the connecting pipe is engaged with the outer wall of the fitting portion of the water-supply coupling section.

The C-shaped retainer includes two retaining wings configured to engage with the joining section of the connecting pipe and the engagement rib of the fitting portion of the body. The two retaining wings are flexible and expendable, and the C-shaped retainer further includes a C-shaped bridge configured to connect the two retaining wings and located opposite to an opening of the C-shaped retainer, wherein a thickness of the C-shaped bridge is equal to a thickness of the joining section so that the C-shaped retainer is engaged with the joining section of the connecting pipe.

Preferably, the body further includes a threaded tube extending from a side thereof, and the body includes a water-supply coupling section extending from a bottom of the body.

Accordingly, the body is connected with the connecting pipe by engaging the engagement rib and two locating protrusions of the body with the groove and the two locking cutouts of the connecting pipe, and the C-shaped retainer is applied to fix the body and the connecting pipe, thus connecting the body and the connecting pipe easily. Preferably, the body is removed from the connecting pipe quickly after detaching the C-shaped retainer, thus maintaining and replacing the connection structure of the valve easily.

### BRIEF DESCRIPTION OF THE DRAWINGS

FIG. 1 is a perspective view showing the assembly of a connection structure of a valve assembly according to a preferred embodiment of the present invention.

FIG. 2 is a perspective view showing the exploded components of the connection structure of the valve assembly according to the preferred embodiment of the present invention.

FIG. 3 is a cross-sectional perspective view showing the assembly of a part of the connection structure of the valve assembly according to the preferred embodiment of the present invention.

FIG. 4 is another cross-sectional perspective view showing the assembly of a part of the connection structure of the valve assembly according to the preferred embodiment of the present invention.

FIG. 5 is a cross sectional view showing the assembly of a part of the connection structure of the valve assembly according to the preferred embodiment of the present invention.

### DETAILED DESCRIPTION OF THE PREFERRED EMBODIMENTS

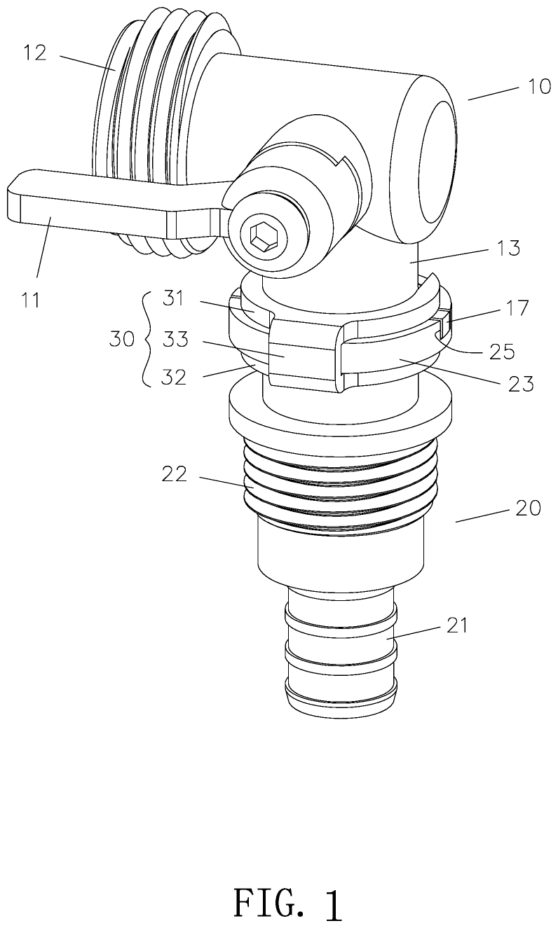

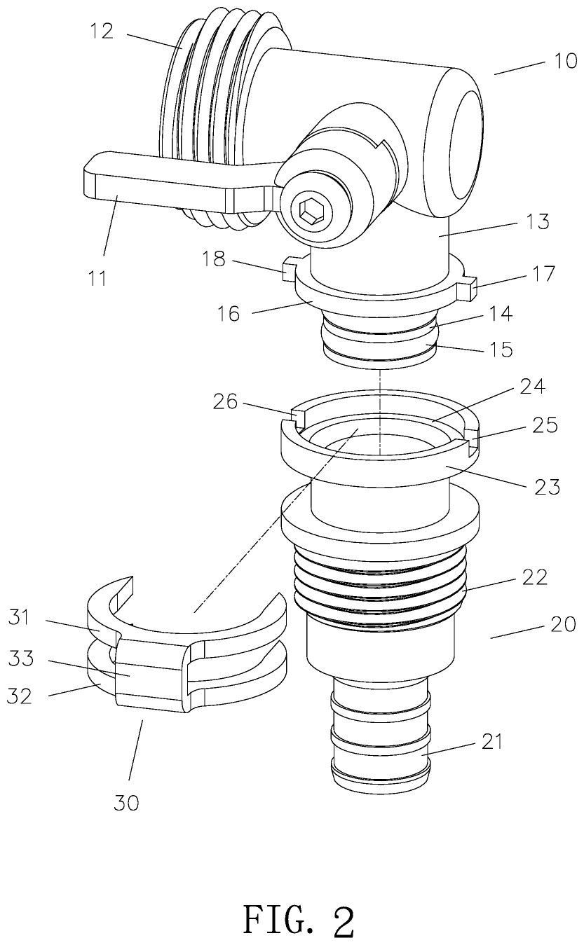

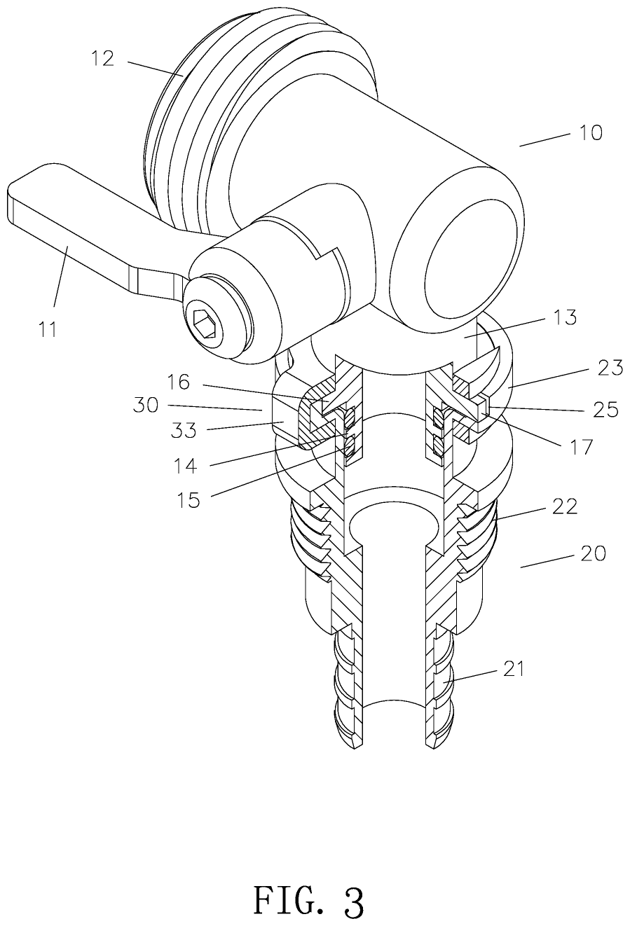

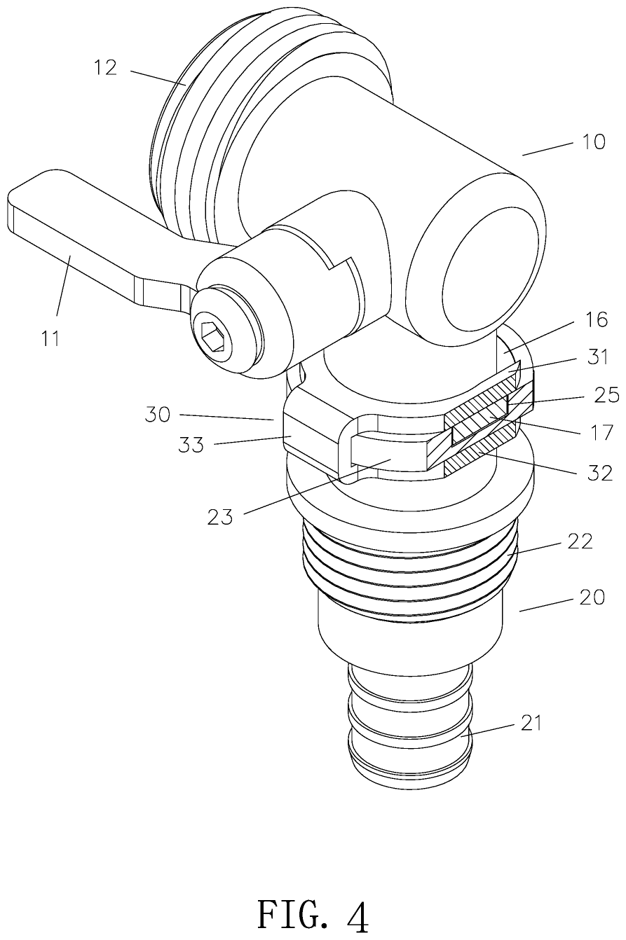

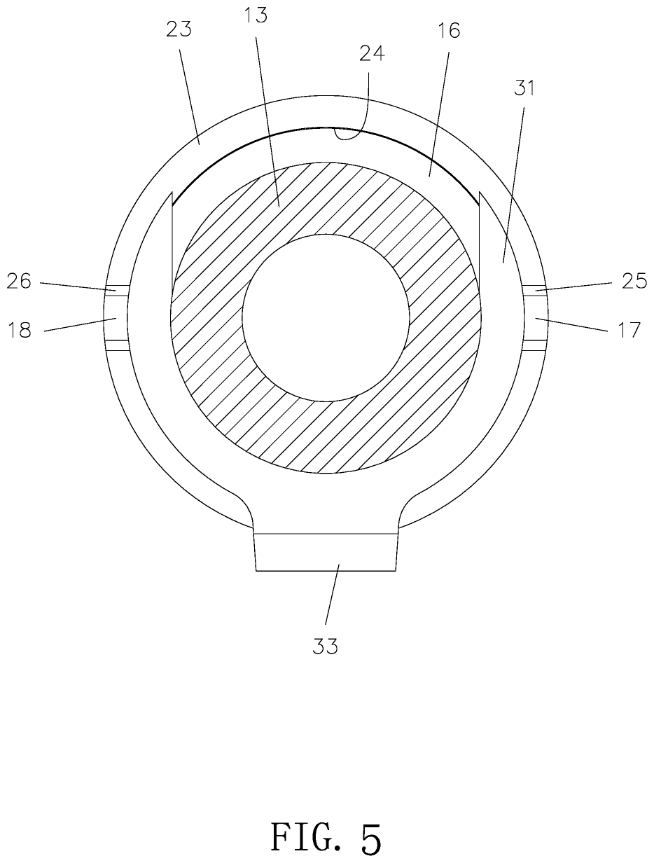

With reference to FIGS. 1-5, a connection structure of a valve assembly according to a preferred embodiment of the present invention, the valve assembly is a control valve applicable for water equipment and an external water supply system, and the valve assembly comprises: a body 10 and a connecting pipe 20 connected with the body 10, wherein the body 10 includes an accommodation chamber (not shown) defined therein and configured to receive a ball valve, and a wrench 11 is configured to turn on/off the ball valve, the body 10 further includes a threaded tube 12 extending from a side thereof, a water-supply coupling section 13 extending from a bottom of the body 10, and a fitting portion 14 extending from a bottom of the water-supply coupling section 13, wherein a diameter of the fitting portion 14 is less than a diameter of the water-supply coupling section 13, and the body 10 further includes a water stop ring 15 engaged on an outer wall of the fitting portion 14, an engagement rib 16 surrounding around the outer wall of the fitting portion 14 and located above the water stop ring 15, and two locating protrusions 17, 18 extending from two opposite positions of the engagement rib 16.

The connecting pipe 20 includes a fixing section 21, a screwing section 22, and a joining section 23 extending from a top of the connecting pipe 20, wherein a diameter of the joining section 23 is more than a diameter of the connecting pipe 20, and the connecting pipe 20 further includes a groove 24 defined in a top of the joining section 23, two locking cutouts 25, 26 formed on two opposite positions of the joining section 23 and configured to engage with the two locating protrusions 17, 18, such that a defining orifice of the connecting pipe 20 is engaged with the outer wall of the fitting portion 14 of the water-supply coupling section 13.

The connection structure of the present invention further comprises a C-shaped retainer 30, and the C-shaped retainer 30 includes two retaining wings 31, 32 configured to engage with the joining section 23 of the connecting pipe 20 and the engagement rib 16 of the fitting portion 14 of the body 10, wherein the two retaining wings 31, 32 are flexible and expendable, and the C-shaped retainer 30 further includes a C-shaped bridge 33 configured to connect the two retaining wings 31, 32 and located opposite to an opening of the C-shaped retainer 30, wherein a thickness of the C-shaped bridge 33 is equal to a thickness of the joining section 23 so that the C-shaped retainer 30 is engaged with the joining section 23 of the connecting pipe 20.

In assembly, the fitting portion 14 of the water-supply coupling segment 13 of the body 10 is fitted with the top of the connecting pipe 20, the engagement rib 16 is engaged with the groove 24 of the joining section 23 of the connecting pipe 20, and the two the two locating protrusions 17, 18 are engaged with the two locking cutouts 25, 26 of the joining section 23 of the connecting pipe 20, thus connecting the body 10 with the connecting pipe 20. Thereafter, the C-shaped retainer 30 is engaged with the joining section 23 of the connecting pipe 20 so that the two retaining wings 31, 32 of the C-shaped retainer 30 abut against the top and a bottom of the joining section 23, and the retaining wing 31 fixes the engagement rib 16 and the two locating protrusions 17, 18 of the water-supply coupling section 13 of the body 10, thus connecting the C-shaped retainer 30 and the body 10. Thereby, the body 10 is connected with the connecting pipe 20 securely. After the C-shaped retainer 30 is detachable from the joining section 23, the body 10 is removed from the connecting pipe 20 easily.

Accordingly, the body is connected with the connecting pipe by engaging the engagement rib and two locating protrusions of the body with the groove and the two locking cutouts of the connecting pipe, and the C-shaped retainer is applied to fix the body and the connecting pipe, thus connecting the body and the connecting pipe easily. Preferably, the body is removed from the connecting pipe quickly after detaching the C-shaped retainer, thus maintaining and replacing the connection structure of the valve easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A connection structure of a valve assembly comprising:
a body including an accommodation chamber defined in the body and configured to receive a ball valve, and a wrench being configured to turn on/off the ball valve, the body further including a threaded tube extending from a side of the body, a water-supply coupling section extending from a bottom of the body, and a fitting portion extending from a bottom of the water-supply coupling section, wherein a diameter of the fitting portion is less than a diameter of the water-supply coupling section, and the body further includes a water stop ring engaged on an outer wall of the fitting portion, an engagement rib surrounding around the outer wall of the fitting portion and located above the water stop ring, and two locating protrusions extending from two opposite positions of the engagement rib;
a connecting pipe connected with the water-supply coupling section of the body to form the valve assembly, and the connecting pipe including a joining section extending from a top of the connecting pipe, wherein a diameter of the joining section is more than a diameter of the connecting pipe, and the connecting pipe further includes a groove defined in a top of the joining section, two locking cutouts formed on two opposite positions of the joining section and configured to engage with the two locating protrusions of the body, such that a defining orifice of the connecting pipe is engaged with the outer wall of the fitting portion of the water-supply coupling section; and
a C-shaped retainer including two retaining wings configured to engage with the joining section of the connecting pipe and the engagement rib of the fitting portion of the body, wherein the two retaining wings are flexible and expendable, and the C-shaped retainer further includes a C-shaped bridge configured to connect the two retaining wings and located opposite to an opening of the C-shaped retainer, wherein a thickness of the C-shaped bridge is equal to a thickness of the joining section so that the C-shaped retainer is engaged with the joining section of the connecting pipe.

2. The connection structure of the valve assembly as claimed in claim 1, wherein the body further includes a threaded tube extending from a side thereof, and the body includes a water-supply coupling section extending from a bottom of the body.
